(19) United States
(12) Patent Application Publication
(10) Pub. No.: US 2025/0229472 A1
(43) Pub. Date: Jul. 17, 2025

(54) SECURE ELEMENT HAVING A CARD-TYPE BODY MADE OF A PLURALITY OF LAYERS, AND METHOD FOR THE PRODUCTION THEREOF

(71) Applicant: GIESECKE+DEVRIENT EPAYMENTS GMBH, Munchen (DE)

(72) Inventor: Josef RIEDL, Attenkirchen (DE)

(21) Appl. No.: 18/850,813

(22) PCT Filed: Apr. 6, 2023
(86) PCT No.: PCT/EP2023/025163

§ 371 Date: Sep. 25, 2024

(30) Foreign Application Priority Data
Apr. 7, 2022 (DE) 10 2022 001 194.8
Apr. 6, 2023 (DE) 10 2023 001 393.5

(51) Int. Cl. B29C 48/21; B29K 35/00; B29K 67/00; B29K 105/00; B29K 105/26; B29L 7/00; B29L 9/00

(52) U.S. Cl. CPC B29C 48/21; B29C 2948/92514; B29K 2023/06; B29K 2035/00; B29K 2067/046; B29K 2105/0067; B29K 2105/26; B29K 2995/002; B29K 2995/0026; B29K 2995/0029; B29L 2007/002; B29L 2009/00

(57) ABSTRACT

A secure element has a card-type body made of a plurality of layers, arranged one above the other and generated by coextrusion. The secure element includes a first layer as the base layer made of a first material having a base polymer, wherein a first color is homogenously distributed in the first layer as the main color of the body. The secure element includes at least one second layer, as the colored layer made of a second material that has a carrier polymer. The base polymer and the carrier polymer have different material properties with randomized polychromatism visible in plan view and in cross section. The at least one second layer forms, together with the first layer in the card body in a random distribution, colored surface regions, which are dominated in part by the color of the first layer and in part by the color of the second layer.

The invention relates to a secure element having a cardlike body composed of a plurality of layers arranged one atop another and generated by coextrusion and also to a method for producing it.

Secure elements having a cardlike body are widespread in the form of chip cards. These are issued in the form, for example, of identity cards, access cards or bank cards (girocard, credit card, payment card, etc.), usually in conjunction with typically as single-color or multicolor cards with a motif. Various kinds of colored design are possible: cards with a colored core, cards with a colored card margin, cards with colored films, transparent and translucent cards, etc. According to implementation, the intention is to convey a particular aesthetic impression. Such cards may be produced in a sheet lamination process or by coextrusion of films.

US 2003/0203177 A1 discloses a method for producing a plastic film via coextrusion by mixing of different color batches, to produce in top view a pattern with random distribution of multiple colors. In this case, two or more material streams discharged from respective extruders are introduced into a cavity of a housing until the mixed material streams are expelled again at a different end of the cavity.

US 2017/0182697 A1 discloses the production of multicolour polymeric films which are based on random mixing of different color components. The polymeric films serve, for example, to produce a kayak, in which two films are brought into a predetermined shape by thermoforming and then welded to one another.

DE 4118624 C1 describes a method for producing a polymeric film having a color structure by extrusion. Prior to the extrusion, a heterogeneous mixture of two or more polymeric materials is provided and a blowing agent is added. The polymeric materials differ for example by being differently colored. The heterogeneous mixture is heated above the softening temperature, thereby activating the blowing agent. The heated heterogeneous mixture is subsequently extruded and thereafter thermoformed. After the thermoforming, a color structure is produced which resembles, for example, a woodgrain.

DE 102017115380 A1 discloses the production of a food-grade film having a randomized color profile, the film being suitable for articles produced by thermoforming such as trays, cups or blister packs. The film possesses a decorative ply which comprises a matrix composed of a first polymeric material and, embedded into the matrix, streaks of a second polymeric material. In terms of visual impression, the film manifests as a multiplicity of stripy streaks running parallel to the machine direction, with irregularly fluctuating width and washed-out margins. The decorative effect is obtained by extrusion of polymeric materials with poor miscibility which preferably differ in their mass flow rate.

An object of the invention is to specify a secure element having a cardlike body composed of a plurality of generated layers that is volume-colored and affords various randomly distributed hues.

This object is achieved by a secure element in accordance with the features of claim 1 and by a method for producing the secure element in accordance with the features of claim 10. Advantageous configurations are evident from the dependent claims.

A secure element having a cardlike body is proposed, which consists of a plurality of layers arranged one atop another and generated by coextrusion. The secure element comprises a first layer as base layer composed of a first material. The first material comprises a base polymer. Distributed homogeneously in the first layer is a first color as base color of the body. The secure element comprises at least one second layer as color layer composed of a second material. The second material comprises a carrier polymer. In a respective second layer, one or more color surface regions in a second color, which is different to the first color, are distributed nonuniformly and in random shapes. The base polymer and the carrier polymer here have different physical properties, so that they do not mix homogeneously, as a result of which, in plan view and in cross section, a randomized (randomly distributed) polychromatism is apparent.

The randomly distributed color surface regions create a unique feature for each individual secure element and may be detected and processed as an unambiguous identifying feature electronically, for example, such as via a camera or by means of a scanner.

The number of the layers arranged one atop another can be chosen in principle in an arbitrary manner. In its most simple form, the secure element may consist of two layers: namely a base layer, in which the base color is homogeneously distributed, and a second layer, which has nonuniformly distributed color surface regions. In a different configuration, there may be a plurality of second layers with respective individual or multiple color surface regions in respective second colors. It will be appreciated that in the case of a plurality of second layers, in a respective second layer the one or the two or more color surface regions in the respective second color are nonuniformly distributed, with the second colors of multiple second layers being preferably different to one another and different to the first color.

A precondition for the randomly distributed polychromatism of the cardlike body both in plan view and in cross section is that the colors of the first layer and of the at least one second layer do not mix homogeneously. The means of achieving this is that the base polymer and the respective carrier polymers of the at least one second layer exhibit specifically different physical properties.

In a first variant, the base polymer and the carrier polymer are polymers having different melt viscosities. For example, the one polymer may comprise a long-chain polycarbonate (PC) of high molar mass and the other polymer may comprise a short-chain polycarbonate (PC). The other polymer is preferably composed of a recycled material, an example being ocean plastic, which is based on marine plastic waste. A material recycled in this way is inherently short-chain. After processing and chain extension, it may then be used, for example, as a base polymer for the base layer.

It is useful if a melt volume flow rate of the one polymer is about 5 cm³/10 min and the melt volume flow rate of the other polymer is about 35 cm³/10 min at a temperature of 300° C. with a mass of 1.2 kg. The melt volume flow rate is also known as MVR.

Alternatively or additionally, the base polymer and the carrier polymer are polymers having different melting temperatures. The physical parameters of melt viscosity and melting temperature are partly interactive here. The melt viscosity is also dependent on the temperature; that is, within certain limits, the melt viscosity can also be adjusted by way of the temperature control. In this configuration, in particular, the one polymer may comprise polylactic acid (PLA) and the other polymer may comprise polycarbonate (PC). For example, the polymer comprising polylactic acid (PLA) may be chosen with a melting temperature of 200° C. and the other polymer, polyester, with a melting temperature of 260° C.

In a further alternative or additional configuration, the base polymer and the carrier polymer are polymers having different polar and nonpolar properties. These may be, for example, polyesters and polar or nonpolar polyolefins. More particularly, the one polymer may be PETG (a glycol-modified polyethylene terephthalate (PET)) and the other polymer may be polyethylene.

It is not necessary for a blowing agent to be added to the carrier polymer or to the base polymer. A secure element produced in accordance with the invention therefore has no blowing agent-induced pores or inclusions.

Further proposed is a method for producing a secure element as configured in accordance with one or more of the above embodiments. The method comprises the steps of:
a) providing a first material stream of a first material with a base polymer in which a first color as base color of the body is distributed;
b) providing a second material stream of a second material with a carrier polymer in which a second color, which is different to the first color, is nonuniformly distributed in one or more color clusters, wherein the carrier polymer of the second material stream and the base polymer have different physical properties, so that the materials are unable to mix homogeneously;
c) combining the first and the second material streams in an extrusion device to give a layer structure with a base layer which comprises the first material with its coloration, and with at least one color layer which comprises the second material with one or more nonuniformly distributed color surface regions.

The method of the invention has the advantage that standard commercial extrusion devices can be used, and in particular there is no need to employ expensive multi-channel dies.

In one useful configuration, the extrusion device is supplied with the first material stream from a first extruder and with the second material stream from at least one second extruder.

The first material stream and the second material stream in the extrusion device, more particularly a compression facility and/or a feed block and/or a die of the extrusion device, are exposed to a melt pressure which is between 10 bar and 100 bar. The melt pressure is preferably between 10 bar and 60 bar. Most preferably, the melt pressure is between 20 bar and 50 bar.

The invention is described in more detail below in the drawing, on the basis of exemplary embodiments. In the figures,

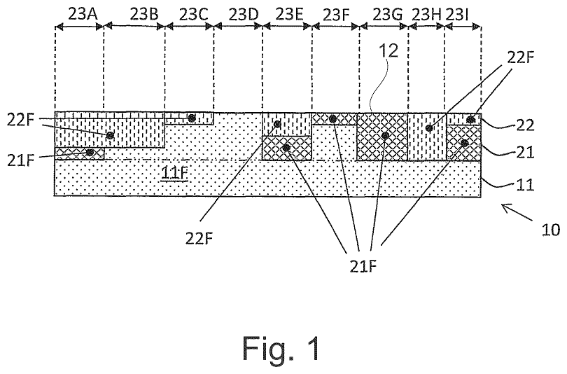

FIG. 1 shows a cross-sectional view of a secure element of the invention which is generated from three layers;

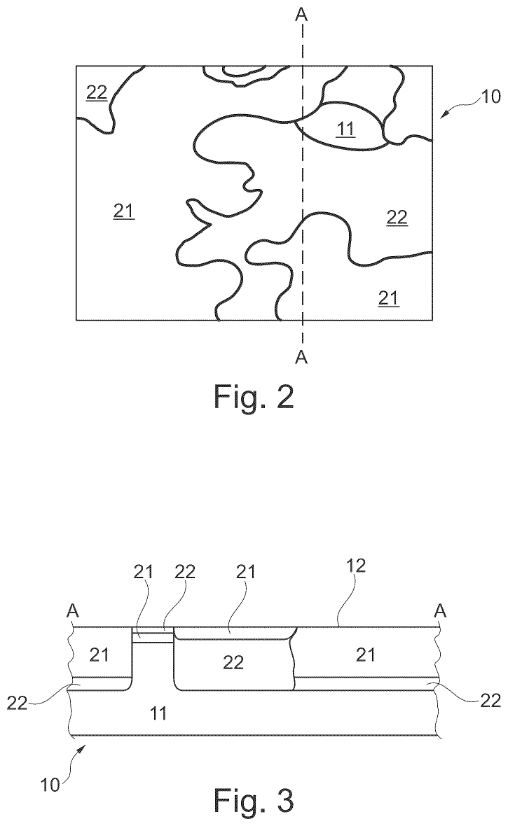

FIG. 2 shows a top view onto a detail of a cardlike body;

FIG. 3 shows a cross section through a cardlike body;

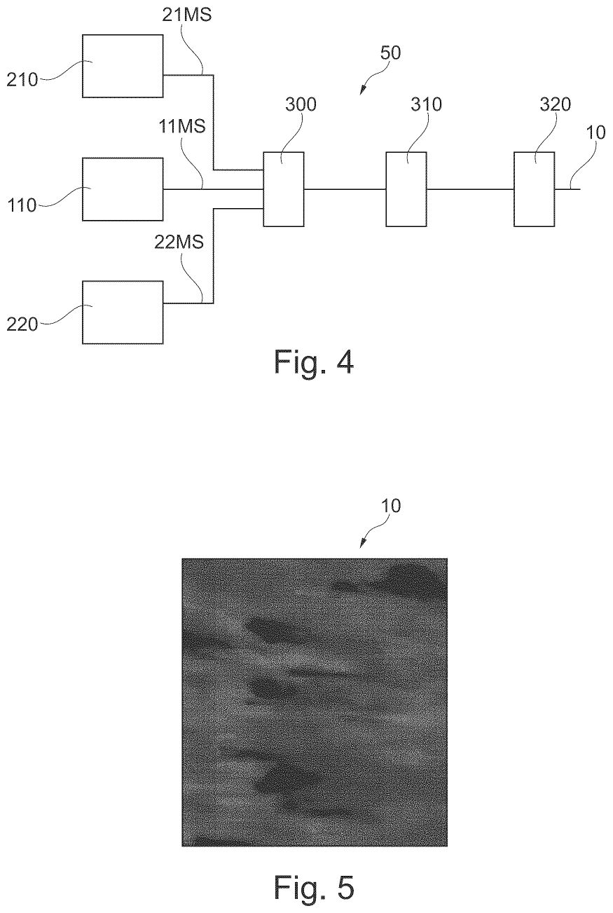

FIG. 4 shows a block diagram of an extrusion device for producing the secure element of the invention; and

FIG. 5 shows a photographic representation of a top view onto a secure element of the invention, produced in accordance with the method of the invention.

FIG. 1 shows a schematic cross-sectional representation of a cardlike body 10 of a secure element in accordance with a first configuration variant. Illustratively, the body 10 of the secure element has a layer structure composed of three layers arranged one atop another and generated by coextrusion. The layer structure possesses at least one visible surface 12, which has a randomized polychromatism which is clearly apparent in top view onto the secure element. Usefully, a randomized polychromatism is also apparent when viewed from the bottom side, opposite the visible top side.

The secure element may be embodied in a known way as a chip card. A chip card of this kind is used, for example, as an identity card, access card or bank card (gyro card, credit card, payment card, etc.), with a chip module integrated in the interior of the card body. A chip module of this kind, which comprises a (semiconductor) chip and a contactless and/or contacted interface, is not represented in any of the figures. The skilled person is familiar with the constructive structure of chip cards, and so an in-depth description is omitted at this point.

The cardlike body 10 of the secure element in the example of FIG. 1 has a three-ply layer structure, with a first layer 11 as base layer and with two second layers 21, 22, each of which form color layers. In the configuration variant shown in FIG. 1, the second layer 21 comes to lie directly on a (e.g. upper) main side of the first layer 11, also called the base layer hereinafter. The second layer 22 is arranged on the side of the second layer 21 that faces away from the first layer 11.

The first layer 11, as base layer, consists of a first material which comprises a base polymer. The base layer 11 frequently consists of a transparent material. Alternatively, the base polymer of the first layer 11 may be blended with color particles, so that the first layer 11 has a first color 11F. The first color 11F as base color may, for example, be white or gray; in principle, any desired color may be chosen here.

Each of the second layers 21, 22 consists of a second material, which in each case comprises a carrier polymer. The carrier polymers of the two second layers 21, 22 are usefully different from one another and also from the material of the base layer 11. The carrier polymers preferably differ in their viscosity. Further, the two second layers 21, 22 are provided with color particles in different colors, which give each of the layers an independent base color. For example, the base color of the second layer 21 may be green, and the base color of the second layer 22 blue. In one particular variant, one of the two layers 21, 22 may also be transparent. To enable mixtures and transitions due to superimposition, the layers 21, 22 are usefully implemented as layers which are not fully opaque but instead slightly translucent, so that when two second layers 21, 22 are superimposed, the lower layer is perceptible through the layer above it and there is a color mixing effect.

In order to achieve a randomly distributed polychromatism of the cardlike body 10 of the secure element, in plan view and in cross section, the base polymer of the first material of the first layer 11 and the carrier polymers of the respective second materials of the second layers 21, 22 have different physical properties. The polymers used for the base layer 11 and for the second layers 21, 22 preferably possess different melt viscosities and/or different melting temperatures or different polar/nonpolar properties.

Sufficient difference between the polymers of the base layer 11 and the carrier polymers of the second layers 21, 22 has the effect that the polymers of the various layers and hence the color particles (color masterbatches) contained therein do not mix homogeneously during the extrusion. The color particles themselves, and the colors/dyes used, are not critical in this respect.

Melt viscosity and melting temperature influence one another. Within certain limits, the melt viscosity can be adjusted by way of the temperature control.

A combination of materials with different viscosities is the result, in the case, for example, of combination of a long-chain polycarbonate (PC) of high molar mass with a short-chain polycarbonate. Each in this case may be used as a matter of choice for the base layer or a carrier polymer.

A combination of materials in which the materials differ by way of melting temperatures is composed, for example, of polylactic acid (PLA) and polycarbonate. Here as well it is possible to choose which of the two polymers is used for the base polymer or for the carrier polymer.

A combination of materials having different polar properties are polyesters and polyolefins (which as a matter of choice may be polar or nonpolar).

Particularly suitable for providing such combinations of materials are recycled materials, such as ocean plastic, which is based on marine plastic waste. Reused or recyclable materials are inherently short-chain and may be used, for example, as base material or carrier material in combination with processed reused materials which have undergone chain extension.

For combinations having different melt viscosities, polymers may be chosen which differ in the melt volume flow rate (MVR). For example, the melt volume flow rate of the one polymer may be 5 cm³/10 min and the melt volume flow rate (MVR) of the other polymer may be 35 cm³/10 min. The melt volume flow rate is valid in each case at a temperature of 300° C. with a mass of 1.2 kg.

Where polymers having different melting temperatures are used, it is possible for example to choose polylactic acid (PLA) having a melting temperature of 200° C. as one polymer and polyester having a melting temperature of 260° C. as the other polymer.

Where polymers having different polar or nonpolar properties are chosen, it is possible to choose PETG as the one polymer and polyethylene as the other polymer.

During the extrusion, the effect of the different physical properties is that there is no homogeneous mixing of the base polymer of the first layer 11 with the carrier polymers of the second layers 21, 22. Instead, in the extruded film, random color surface regions 23 are formed, in each of which the polymer of one layer and hence the color admixed to this polymer dominates, by having a higher volume fraction there than the other. Where, for instance, two polymers are used which differ in their viscosity, a film is formed which has color surface regions in which the polymer of high viscosity dominates, and color surface regions in which the polymer having the lower viscosity dominates.

The color surface regions have random sizes and random marginal contours. At their surface region boundaries, in terms of perception to a user, they may exhibit fluid transitions from one to the other, or the surface region boundaries are almost sharply defined. The color surface regions may also differ in surface quality. For example, surface regions in which a material of low viscosity dominates may have an uneven surface, whereas surface regions in which a material of high viscosity dominates may by comparison therewith appear very smooth and uniformly even. Such differences in surface quality may be desirable in order to support the impression of color distribution. Alternatively, provision may be made to even out such differences in surface quality and in layer thickness by means of a pressing process. In this way, in plan view, a randomized polychromatism is produced.

On the basis of their different physical properties, the carrier polymers of the second layers 21, 22 exhibit mixing which, while of undefined quality, is nevertheless only poorly homogeneous. Above all, the different carrier polymers mix into one another. Likewise as a consequence of the different physical properties and also as a consequence of deliberate extruder parameter settings, the merging of the carrier polymers of the second layers 21, 22 in the extrusion device 50 is further accompanied by—wanted—material flow irregularities, which support or bring about nonuniform distribution of the carrier polymers of the second layers 21, 22.

Because of these adverse effects on mixing, the carrier polymers in the surface flow practically in general do not arrange themselves in homogeneous distribution one atop another. Instead, regions are developed in which only one of the carrier polymers is present; regions in which a thin layer of the first carrier polymer overlaps with a thicker—by comparison therewith—layer of the second carrier polymer; regions in which the two carrier polymers are mixed; and regions which are formed substantially by the base layer. FIG. 1 schematically illustrates possibilities of overlapping.

FIG. 1 shows a cross section through a cardlike body 10 composed of a base layer 11 and two second layers 21, 22. The body 10 possesses a constant total thickness. Within the constant total thickness, the thickness distributions of the three layers 11, 21, 22 vary vertically with respect to the visible surface 12. They do not lie one atop another uniformly, but instead varying, random thickness distributions are formed, relative to the visible top side 12; only the base layer 11 is developed as a continuous carrier layer and is present, albeit likewise with varying thickness, over the entire area of the body 10.

In the example, the first second layer 21 possesses a slightly translucent color 21F, the second second layer 22 a significantly translucent color 22F by comparison therewith, and the base layer 11 a strongly translucent color 11F.

Owing to the differences in local distribution of the layers 11, 21, 22, for the random situation represented in FIG. 1, the color impression produced for a viewer from left to right is that of a sequence of color surface regions 23. In a first color surface region 23A, called region for short below, the layer 22 is thicker than the layer 21 and, with its color, dominates the color impression. In the bordering region 23B, the first second layer 21 is absent and the color impression is dominated by the color 22F of the second layer 22. In the bordering region 23C, only the layer 22 is present, in a low thickness, and so the color impression is determined by a mixing of the significantly translucent color 22F of the second second layer 22 and the strongly translucent color 11F of the base layer 11. In the bordering region 23D, only the base layer 11 is present and the color impression is determined by its color 11F. In the region 23E, the two second layers 21, 22 are present in equal thickness, and so their colors 21F, 22F mix with one another, with the less translucent color 21F of the first second layer 21 showing through the more strongly translucent color 22F. In the bordering regions 23F and 23G, in different thicknesses, only the layer 21 is present in each case. The color impression is determined, accordingly, in one case more strongly and in one case more weakly by the color 21F of the layer 21. In the region 23H, the layer 22 determines the color impression; in the region 23I, the colors 21F, 22F of the layers 21, 22 mix with one another, with the color 21F predominating in the color impression.

If, for example, the first color 21F is blue, the second color 22F is green, and the color of the base layer 11 is white, then for the random situation represented in FIG. 1, a viewer is presented for example with a sequence of color impressions from left to right as follows: the region 23 A appears greenish-turquoise, the region 23B distinctly green, the region 23C slightly green, the region translucent-white, the region 23E turquoise, the region 23F light blue, the region 23G blue, the region 23H green, and the region 23I blue-turquoise.

The number and distribution of the respective color surface regions 21F, 22F, 11F of the respective second layers 21, 22 and of the base layer 11 are random and independent of one another.

FIG. 2 shows, in a top view onto the visible surface 12, a detail of a cardlike body 10 of a security element having a base layer 11 and two second layers 21, 22, which have been joined to one another to form a random distribution of different, randomly shaped color surface regions 23 in accordance with the respective colors of the layers 21, 22.

In nonuniform distribution, surface regions are formed in which the first of the second layers 21, 22 and hence its color dominates, and regions in which the second of the second layers 21, 22 and hence its color dominates, and also regions in which the base layer 11 and hence its color dominates. If one of the second layers 21, 22 is transparent, this results, in regions dominated by this second layer, in a distinct lightening and reduced opacity of the color of the other second layer 21, 22. For example, an intense blue becomes a milky light blue. If the base layer as well is transparent, the effect is reinforced.

FIG. 3 illustrates schematically the development of different color surface regions on the basis of a cross section through the distribution shown in FIG. 2, along the line A-A. In a first region, as seen from top to bottom in FIG. 2, the second layer 21 is dominant; in an intermediate region, the base layer 11 is dominant; in a following region, the second layer 22 is dominant; and in a subsequent region, the second layer 21 is again dominant. It is indicated in each case that in the regions dominated by a second layer 21, 22 or the base layer 11, the materials of the respective other layers are generally likewise present, but at a much lower concentration. The surfaces of the mutually bordering layer regions, as indicated in FIG. 3, need not be planar. As a result, in accordance with the varying layer thicknesses, desired random color profiles may be produced within a region.

Usefully, the structure shown schematically in FIG. 1 is symmetrical and the cardlike body 10 is composed of five layers, with two second layers 21, 22 being placed each symmetrically on both sides of the base layer 11. In this way, on both sides of the first layer 11, a random distribution is formed of color surface regions 23, as described earlier. The number and distribution of the color surface regions 23 of the respective second layers 21, 22 here are independent of one another. In further variants, it is also possible in each case for more than two second layers 21, 22 to be applied on both sides of the base layer 11; it is also conceivable for different numbers of second layers 21, 22 to be applied on the sides of a base layer 11. Further, the base layer 11 may also consist of multiple layers.

In the production process which is elucidated in more detail below with reference to FIG. 4, a material stream for the second layers 21, 22 may be divided.

FIG. 4 shows an extrusion device 50 which is used for producing the cardlike body 10 in accordance with the exemplary embodiments in FIGS. 1 and 4 for a secure element. The extrusion device 50 comprises a first extruder 110 for delivering a first material stream 11MS composed of the first material with the base polymer. Further provided are two second extruders 210, 220 for delivering a respective second material stream 21MS, 22MS with a carrier polymer. The first material stream 11MS and the two second material streams 21MS, 22MS are supplied to a feed block 300.

Starting materials for the extruders 110, 210, 220 are in each case polymers in pellet form. The starting material is usefully predried at around 60° C. to 80° C. Blowing agents are not added.

In the feed block 300, the material streams are united to form a combined material stream, which is expelled as a sheet stream via a die 310. The sheet stream possesses, for example, a layer structure, as represented in principle in FIG. 1.

In an optional downstream compression facility 320, the sheet stream and hence the layer structure is consolidated to form a film. The film contains the later cardlike bodies 10.

The melt pressure in the die 310 is usefully between 10 bar and 100 bar. The melt pressure is preferably between 10 bar and 60 bar or 20 bar and 50 bar.

In black-and-white representation, FIG. 5 illustrates a realistic pictorial top view onto a cardlike body 10 implemented as described above, where the random distribution of color surface regions 23 composed of three colors (black-gray-white, corresponding for example to black-blue-green) is apparent. As a result, the cardlike body 10 exhibits an unambiguous optical feature which can be optically detected and evaluated.

All of the structural elements described above may in principle also be freely combined with one another other than described with reference to the exemplary embodiments; the exemplary embodiments should not be understood as a limitation to particular combinations of elements.

1.-15. (canceled)

16. A secure element having a cardlike body with a visible surface composed of a plurality of layers arranged one atop another and generated by coextrusion, comprising:
a first layer as base layer composed of a first material which comprises a base polymer,
at least one second layer as color layer composed of a second material which comprises a carrier polymer, the at least one second layer possessing a color,
the at least one second layer and the first layer are arranged one atop another in varying thickness distributions vertically with respect to the visible surface of the body in such a way that in nonuniform distribution, color surface regions are formed in which the at least one second layer and therefore its color dominates, and also color surface regions in which a different layer of the cardlike body and therefore its color dominates,
wherein the base polymer and the carrier polymer have different physical properties, so that they do not mix homogeneously, as a result of which, in plan view onto a cardlike body, a randomized polychromatism is apparent.

17. The secure element as claimed in claim 16, wherein the layers arranged one atop another are free from blowing agent-induced pores or inclusions.

18. The secure element as claimed in claim 16, wherein the first layer is transparent or in the first layer a first color as base color of the cardlike body is distributed.

19. The secure element as claimed in claim 16, wherein the base polymer and the carrier polymer are polymers having different melt viscosities or having different melting temperatures.

20. The secure element as claimed in claim 16, wherein one polymer comprises long-chain polycarbonate of high molar mass and the other polymer comprises short-chain polycarbonate, more particularly composed of recycled materials.

21. The secure element as claimed in claim 16, wherein a melt volume flow rate of the one polymer is about 5 cm³/10 min and the melt volume flow rate of the other polymer is about 35 cm³/10 min at a temperature of 300° C. with a mass of 1.2 kg.

22. The secure element as claimed in claim 16, wherein one polymer comprises polylactic acid and the other polymer comprises polycarbonate.

23. The secure element as claimed in claim 16, wherein the one polymer is polylactic acid having a melting temperature of 200° C. and the other polymer is polyester having a melting temperature of 260° C.

24. The secure element as claimed in claim 16, wherein the base polymer and the carrier polymer are polymers having different polar or nonpolar properties.

25. The secure element as claimed in claim 16, wherein the one polymer is PETG and the other polymer is polyethylene.

26. The secure element as claimed in claim 16, wherein the carrier polymer is translucent, and so a further second layer arranged under the second layer containing the carrier polymer is perceptible through the carrier polymer.

27. A method for producing a secure element as claimed in claim 16, with the steps of:
a) providing a first material stream of a first material with a base polymer which possesses a first color as base color of the body;
b) providing at least one second material stream of a second material with a carrier polymer which possesses a second color, which is different to the first color,
wherein the carrier polymer of the second material stream and the base polymer have different physical properties, so that they do not mix homogeneously;
c) uniting the first and the at least one second material streams in an extrusion device to give a layer structure with a base layer which comprises the first material and with at least one color layer which comprises the second material,
wherein the layers lie one atop another in varying thickness distributions vertically with respect to the visible surface of the body and form nonuniformly distributed color surface regions, as a result of which, in plan view onto the body, a randomized polychromatism is apparent.

28. The method as claimed in claim 27, in which the extrusion device is supplied with the first material stream from a first extruder and with the second material stream from at least one second extruder.

29. The method as claimed in claim 27, in which the first material stream and the second material stream in the extrusion device, more particularly a compression facility and/or a feed block and/or a die of the extrusion device, are exposed to a melt pressure of between 10 and 100 bar.

30. The method as claimed in claim 27, wherein in the uniting of the material streams, material flow irregularities of the material streams of the second material are permitted which bring about nonuniform distribution of the carrier polymers of the second layers.
